(19) United States
(12) Patent Application Publication
(10) Pub. No.: US 2015/0026042 A1
(43) Pub. Date: Jan. 22, 2015

(54) SYSTEM AND METHOD FOR ELECTRONIC CASH-LIKE TRANSACTIONS

(71) Applicant: Luiz M Franca-Neto, Sunnyvale, CA (US)

(72) Inventor: Luiz M Franca-Neto, Sunnyvale, CA (US)

(21) Appl. No.: 13/947,067

(22) Filed: Jul. 21, 2013

(51) Int. Cl. G06Q 20/06; G06Q 20/38

(52) U.S. Cl. CPC G06Q 20/065; G06Q 20/383
USPC 705/39

(57) ABSTRACT

An electronic money system where ownership of each cent of properly created and labeled electronic money is manifested and confirmed by the ability of a client to change specific secret content in pre-determined field assigned to said cent of electronic money. Said ability is granted upon demonstration of knowledge of the current content of said pre-determined field. An electronic money system capable of purchases, transfers, deposits and remittances with anonymity and convenience similar to ordinary cash. An electronic system whose enabling client computational resources can be downloaded as a software application and can be operated under yearly subscription fee.

This patent application is related to a provisional application No. 61/674,379, “System and Method for Electronic Cash-like Transaction”, submitted to the US PTO on Jul. 22, 2012, by the inventor of this current patent application.

### BACKGROUND OF THE INVENTION

1. Field of the Invention

The invention relates generally to electronic currency, and more particularly to how to ensure protection against electronic currency counterfeiting and how to ensure untraceability of monetary transactions and bearer's anonymity at the same time double spending the same electronic money is safely precluded. This document also advances possible business models built upon this invention.

2. Background

In typical transactions based on currency, also referred to as transactions in cash in this document, it is important to (1) guarantee against counterfeiting and (2) guarantee the untraceability of the transaction and the anonymity of the bearer of cash. These attributes (1) and (2) of transactions in cash are highly desirable attributes and differentiate those transactions in cash from the variety of other financial transactions involving the banking system or credit card operators.

Therefore, there is a need for an electronic money system to provide the users of electronic money the benefits (1) and (2) the users enjoy while using ordinary cash.

Moreover, (3) its important that double spending the same money be precluded by the very design of the electronic money system to further develop the similarities between electronic money usage and ordinary cash transactions.

And, since it's not recommended to send ordinary cash by mail, it will be an advantage of electronic money over cash if the objectives of such a cash transmission between individuals can be accomplished safely when the individuals use electronic money. Hence, there is a need to support (1), (2) and (3), and add provisions to the system handling electronic money to make it also conducive to the remittance of monetary value between physically distant remitter and receptor. Specially if such a remittance also preserves the remitter anonymity.

### SUMMARY OF THE INVENTION

The invention is a system and method for electronic cash-like transactions, which offers (1) validation of the electronic money used in a purchase of goods or services, and (2) untraceability and anonymity for the bearer of electronic money, and (3) precludes double spending of the same electronic money. Mobile devices and tablets can use the system in this invention and will behave as electronic wallets for the user. By agreement between banks, electronic cash is convertible into ordinary cash even when the conversion is performed by a bearer different from the original purchaser of electronic money and the conversion is executed at a bank different from the original bank, which created the electronic cash. Moreover, electronic money, by interbank association and bank-client agreement, can be exchanged in perfect parity anytime the client request, or any time a bearer of legitimate electronic money thus request, regardless of him/her having account in a particular bank participating in the interbank association which offered electronic money.

The (3) double spending of the same electronic money is precluded by design of the system.

The invention described in this document support (1), (2) and (3) by assigning ownership of each cent of electronic money to whoever has the knowledge required to change an specific field of ownership appended to each cent of electronic money in circulation.

For a fuller understanding of the nature and advantages of the present invention, reference should be made clear by the following description together with the accompanying figures. The related and complementary details of the invention for aspects (1), (2) and (3) listed above will be described together in this provisional application. Examples of claims to this invention in its aspects (1), (2) and (3) are stated at the end of this document.

Even though embodiments of this invention that use mobile devices create a virtual wallet experience very similar to that of an ordinary cash wallet, the skilled in the art will recognize that other devices with adequate computational capabilities can be used with this invention.

### BRIEF DESCRIPTION OF THE DRAWINGS

FIG. 1 shows the typical elements, a bank and a client, and an example of steps in a transaction where electronic cash is dispensed by the bank to the client in lieu of ordinary cash.

FIG. 2 shows an example of information exchange between a bank and an electronic cash bearer for an anonymous update of the bearer's ownership signature. This exchange can be launched by the bearer at any time of the bearer's discretion.

FIG. 3 shows an example of information exchange between a bank and a client depositing electronic money for cash deposit in one of the client's account.

FIG. 4 shows an example of information exchange between a bank and a client depositing electronic money to withdraw cash.

FIG. 5 shows an example of local information exchange between a person A and a person B, both users of electronic money, when A purchase good or service from B. Person B uses the network to check with a bank the validity of person A's electronic money and requests a change in the ownership content for A's electronic cash. Upon receiving confirmation from the bank for the ownership content change, B delivers the goods or services to A.

FIG. 6 shows an example of information exchange between a person A and a bank to use electronic money to transfer cash between accounts in the same or different banks in a bank association supporting electronic money.

FIG. 7 shows an example of remittance using electronic money to an account or to a person.

### DETAILED DESCRIPTION OF THE INVENTION

### 1.0 Devices, Clients and Banks

Like ordinary wallets, tablets and smart cell phones in particular tend to be carried by their users wherever they go. Thus, tablets and smart phones are used in some of the embodiments described in this document. The system and method of this invention are described below as illustration. The skilled in the art will recognize alternative realizations without departing from the spirit of the invention.

In the interest of brevity and clarity in the descriptions, tablets and smart phones or any other mobile device used for financial, banking, payment or remittance transactions with electronic money will be referred to indistinguishably as the mobile device throughout this document.

A. Loading the Mobile Device with Electronic Money

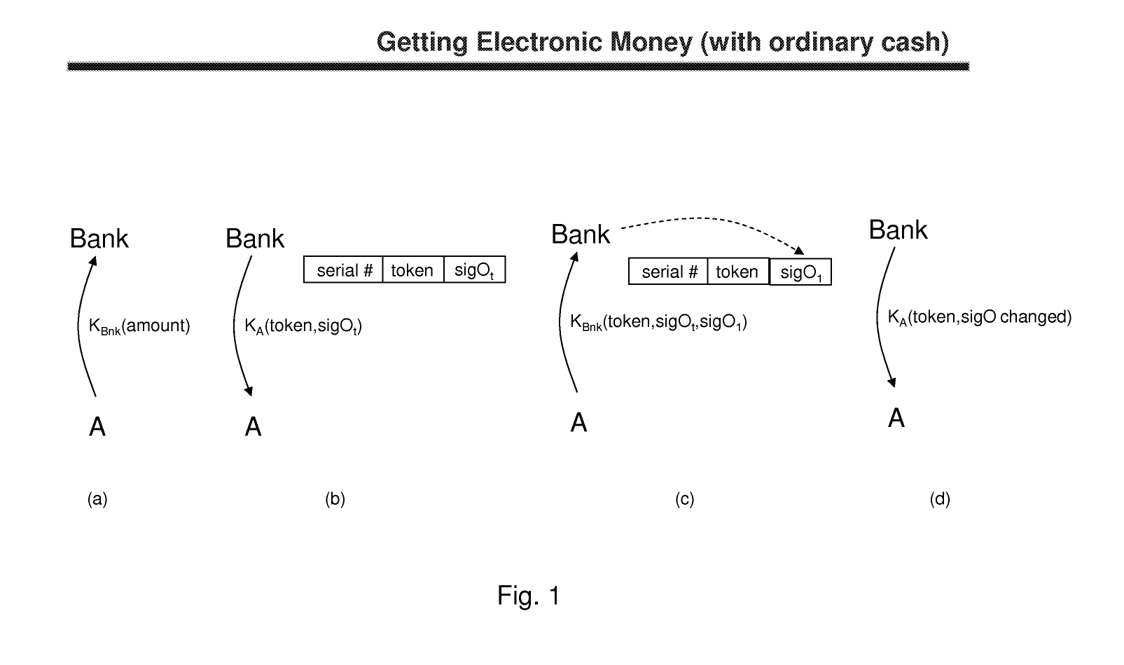

In FIG. 1, in an embodiment of the invention disclosed in this provisional patent application, an example of information exchange is illustrated between a Bank (or an automatic teller machine) and client A, where the user charge his mobile device with electronic money. His mobile device runs an application that communicate with the bank. Each cent of electronic money in circulation has its serial number, token and ownership fields contents kept in the bank or bank association database.

In FIG. 1, in an embodiment, only the token number and ownership field content of electronic money is known to clients.

In FIG. 1, in an embodiment of this invention there is no anonymity in this specific exchange between the bank and client A. That's because the bank is the sole generator of electronic money, and in the interest of making electronic money be indistinguishable from and fully convertible into ordinary cash, the bank needs to ascertain whether client A has indeed sufficient reserves or assets to withdraw cash or electronic money. Cash will be the underlying reference instrument for electronic money, and the bank or any of its associated institutions in the operation of electronic money will be able (and, for the solidity of the acceptance of electronic money, preferably obliged) to return cash or deposit cash in a account belonging to the client whenever a client present the bank electronic money and request cash or cash deposit.

Note also that the communication between bank and client A shown in FIG. 1 could be carried over a variety of physical media and channels. The client with his/her mobile device might be in the bank's premises or accessing his/her bank account through a wireless link, radio or infrared, or through the Internet, or through any other suitable means of communication.

One of the innovations in this disclosure is the concept that legitimate ownership over electronic money is manifested or demonstrated by the ability of its owner to change a specific field in the electronic money descriptive definition. This specific field is defined to contain an ownership signature (sigO). The bank and the bank association operating electronic money according to this invention know serial number, token and ownership content for each cent of electronic money in circulation. In order to demonstrate or confirm ownership by changing the ownership content field of a cent in circulation, the presumed owner need first to present the token number associated with each cent of electronic money and its current sigO value to the bank Besides the bank and the bank association, sigO for a cent of electronic money is only known to the owner of that cent of electronic money. A request by a client to change the current content of sigO, say sigO₁, to a new value, say sigO₂, is only performed by the bank if its presented with the current sigO of that cent by the requestor. Response by the bank to the requestor confirms the validity of the electronic money and its ownership by the requestor.

The request to change the field sigO can be anonymous and the bank will change its content to a new value whenever the bank is presented with the correct current content of that field. Since in an anonymous request the bank does not know who among its clients made the change request, the bank is obliged to confirm the change in sigO field by broadcast message.

As will be seen double spending is precluded by the sequence of actions used in a embodiment of this invention to be described later in this document. Those actions are executed to complete a purchase, a deposit, transfer or remittance of electronic money.

Its important to observe that the owner of electronic money can request change in the sigO content as many times and whenever he/she desires, and in fact he/she is recommended to frequently make such a change request to the bank. Therefore, there will no necessary correspondence between request for changes in sigO content and purchase, deposit, transfer or remittance of monetary values. This is important and is another innovative aspect of this invention that allows electronic money to be kept in circulation and change hands untraceably in effect manifesting very similar attributes enjoyed in the use of ordinary cash.

Moreover, in one embodiment any client can at any time request anonymously the bank to confirm the validity of a token number of electronic money.

Alternatively, the bank can broadcast to all clients the means to locally check the validity of any cent of electronic money in circulation. In one embodiment this is accomplished by the bank broadcasting to all clients in the system a key and the results obtained by encrypting the token of all electronic money in circulation with that key. In such an embodiment, each client can encrypt with said key each token of the electronic money in which it has an interest. This client will need only to see if the result produced by such an encryption matches any of the results broadcasted by said bank.

Assuming for discussion the client is physically at the Bank in FIG. 1, the information exchange between the Bank and the client's smart phone can use a variety of proprietary connections, cribs or cables. In the absence of these proprietary solutions, the client's smart phone can also read (using its camera) or display responses in its screen to be read by a Bank's camera. All these and similar alternatives are readily conceivable by the skilled in the art without departing from the spirit of this invention.

In FIG. 1, in a embodiment to provide security, the client communicate with the bank using the bank's public key (K_{Bnk}). Upon request of an amount of money in electronic currency, the Bank generate a serial number and a token for each cent to be dispensed to the client's electronic wallet using one of the client's public key (K_{A}). Serial numbers are attached to the smallest currency unit, which for the purpose of this description will be 1/100 of a dollar, or a cent. Accordingly, in FIG. 1a, client A uses the bank public key to identify himself/herself and request an amount of electronic money. In FIG. 1b, the bank checks availability of funds for client A, and using client A's public key send him the token for each of the cents in the amount requested by client A. The token is a summary code generated by a one-way function from the serial number of each cent created. The bank appends a temporary sigO value, sigOₜ, to each of the cents created for client A, and also inform those contents to client A using client A's public key. This step can be seen as correspond to the bank relinquishing ownership of the electronic money to client A and is a mechanism repeatedly used by parts exchanging electronic money in various embodiment of this invention to transfer ownership of electronic money.

In FIG. 1c, client A requests change in the content of sigO in each cent of his just received electronic money from sigOₜ to a new content, sigO₁. In FIG. 1d, the bank confirms the change in the sigO content to sigO₁. This step settles client A as the owner of each of those requested cents, and its now in the powers of client A to relinquish ownership of any of those cents by informing another person the sigO content of his cents. This possible future relinquishing action by client A may be carried over the Internet or any other adequate medium in a purchase, transfer or remittance by client A as it will be described later in this document.

In another embodiment, the bank can keep track of all the previous sigO content and instead of substituting its content with an updated value, the bank can append the new sigO content to the older sigO content. This may help the bank reconstruct the historical series of sigO content modification in case of unexpected disruptive events in the network.

### B. Requesting Anonymously a Change of Ownership Content

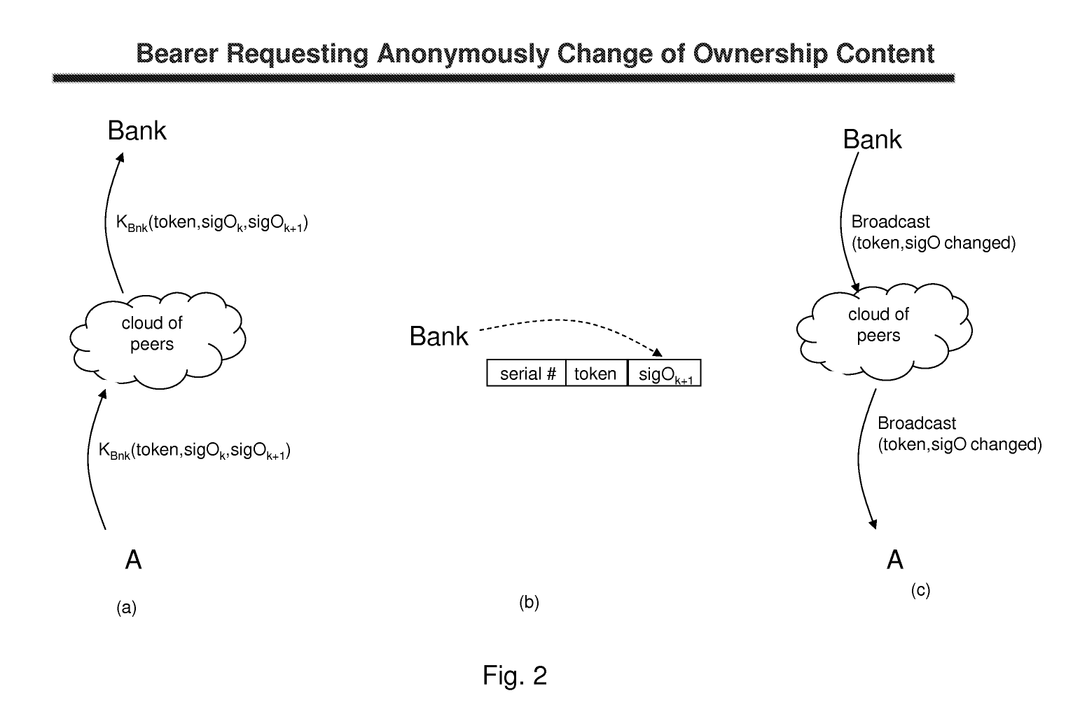

FIG. 2 shows a simplified sequence of exchanges between a client A and the bank when the client A anonymously requests a change ownership content, i.e. a change in the content of the field sigO of the client's electronic money cents. Anonymity is provided by randomly determining which peer client of client A in the electronic money network is to forward client A's request to the bank. Alternative embodiments can use a trusted intermediary entity in the network to receive those anonymous request from the clients and forward them to the bank. This second case would correspond in effect to the special case of assigning one specific client to be the sole peer for forwarding requests from all peers to the bank. Therefore, embodiment in FIG. 2 is a more general illustration for anonymous request from clients to the bank.

In the illustrated embodiment of FIG. 2a, client A uses the public key of the bank and encrypt his request for change in the ownership field, sigO, of a cent of electronic money in his possession. In FIG. 2, all clients besides A are in the cloud of peers. The encrypted request from A is sent to a randomly chosen peer among any of the clients in the electronic money network. That first peer client may directly forward the request to the bank or sent it to another peer. The total number of peers re-sending the request before it is finally forwarded to the bank can also be a parameter of an embodiment of the invention.

As shown in FIG. 2b, The bank receives the forwarded request originally from A, checks if the current ownership content of the cent with the same token value matches sigOₖ sent in the forwarded request, and if so, changes the ownership content to sigOₖ₊₁ as requested. The new ownership content can either substitute the old content or be appended to it.

Since it was an anonymous request, the bank doesn't know the which of the clients made the request and by design the peers will not keep track of which other peer forwarded the request to them. Anonymity, another important innovation aspect of this invention, is therefore achieved by peer behavior in the network without resorting to specific features of the underlying network protocols used in the underlying network used for communications. Or, stated equivalently, the bank will have no information to trace back to the originator of the request of change of ownership content using solely the information provided to the bank in the forwarded request itself. And, the bank could only trace back to the originator of the request if the peer clients purposefully and in coordinate behavior conspired to inform the bank who forwarded the request in every hop. The peers however will be programmed not to save nor forward any information on the client who forwarded the request to them, preserving the anonymity of the original requestor of change in ownership content.

This anonymous request can be launched by a client at any time and therefore will be uncorrelated with actual electronic money purchases or transfer of ownership.

In FIG. 2c, the bank sends a broadcast message to all clients confirming that the ownership content of the electronic money referred to by the token number was changed as requested.

The skilled in the art will recognize that time stamps kept by the requestor and also randomly timed repeated requests can be used by the requestor to augment confidence in the requestor that the bank is really confirming the requestor's requests and not by coincidence the requests from another client trying to double spend the same money.

### C. Depositing Electronic Money as Cash in an Account

A client requesting his electronic money to be deposited as cash in a bank account may make this request as either an anonymous request using the cloud of peers as described for request of change in ownership above or, to ensure only authorized deposits are allowed by the beneficiary, make this request directly to the bank informing his identity as the payer.

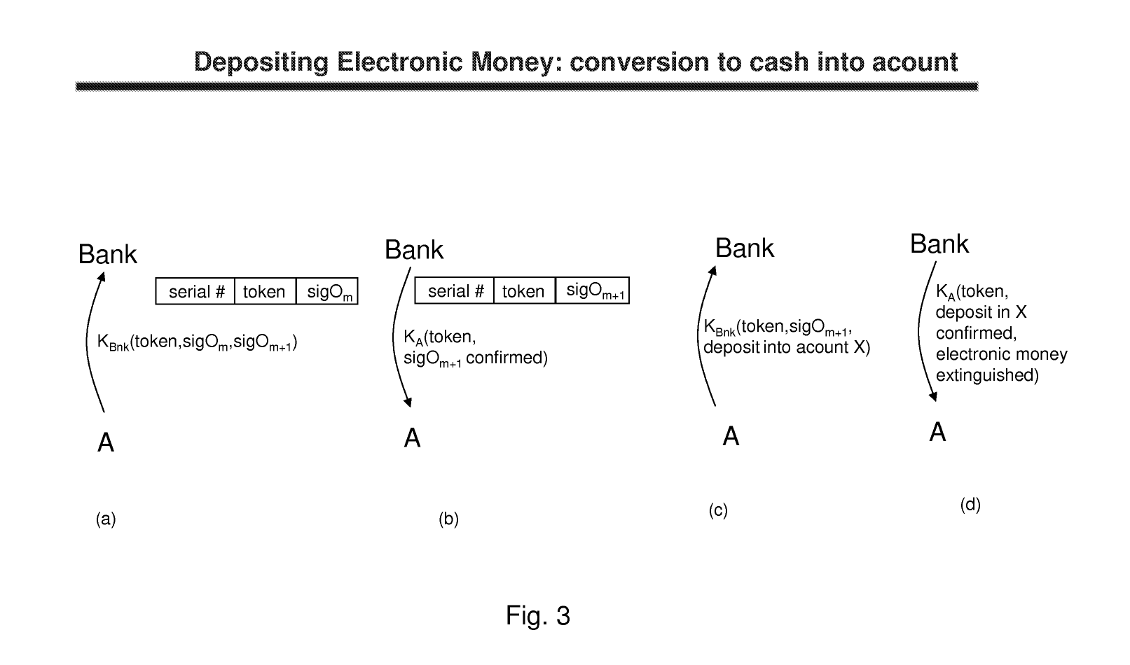

In an embodiment shown in FIG. 3, client A uses public key cryptography in his communications with the bank for communication protection. Client A identifies himself to the bank, and demonstrate he is the owner of the electronic money by requesting a change in the ownership field presenting its current content (FIG. 3a). The bank confirms the change of ownership content by communicating with client A using client A's public key (FIG. 3b). Client A makes a request for deposit of the electronic money he owns (due to ownership content being presented to the bank again in FIG. 3c) into an account X in the bank. Bank process the request and responds using public key of client A (FIG. 3d).

Note in FIG. 3d that once the bank converted electronic money into cash, the bank extinguishes the corresponding electronic money, for instance, by removing the corresponding serial numbers, tokens and ownership fields from the records of electronic money in circulation.

### D. Withdrawing Electronic Money for Ordinary Cash

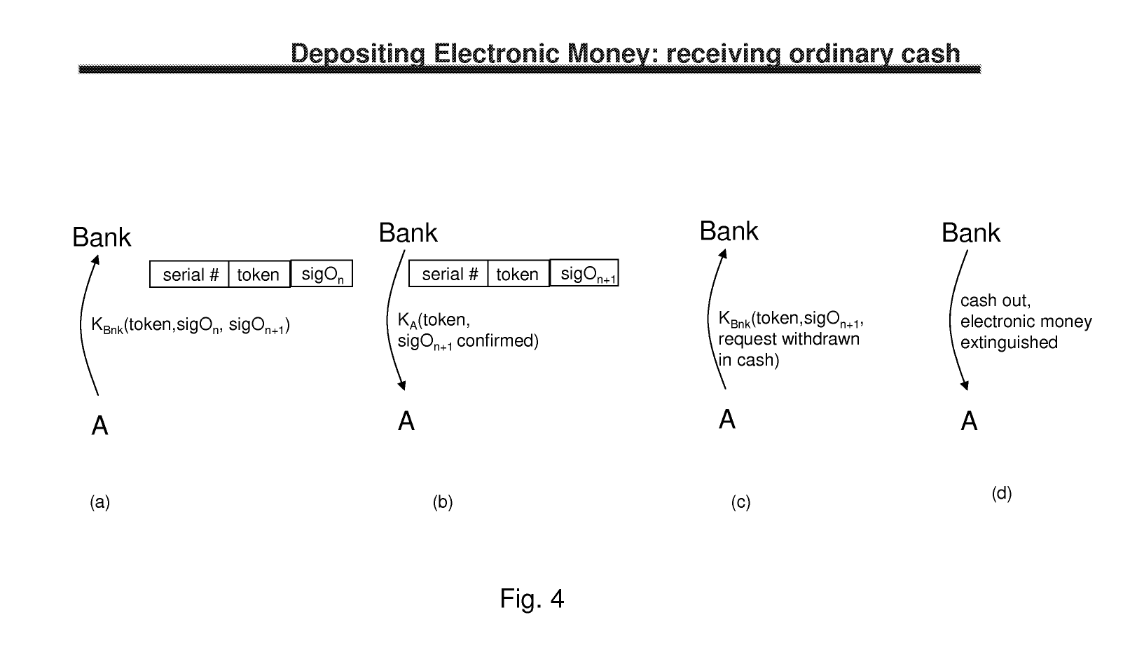

In FIG. 4 shows an embodiment where electronic money is converted into ordinary cash and withdrawn by a client. The skilled in the art will find alternatives where client A may prefer to remain anonymous and make use of the peer of clients described before while withdrawing cash at the bank's premises or at an automatic teller machine.

In an embodiment of this invention, banks in an association supporting electronic money circulation will convert electronic money into cash whenever requested upon demonstration of ownership by either an identified or anonymous bearer who has the knowledge of both the token and associated ownership content of each cent of electronic money requested to be converted and withdrawn as ordinary cash.

In FIG. 4, a simplified sequence of exchange between an identified client and a bank is shown. FIGS. 4a and 4b show the initial request from the client for the bank to change the ownership content. The client is identified and the bank can respond confirming the change using the client's public key. In FIG. 4c, the client demonstrates his ownership of the electronic money related to the token number, and request withdraw in cash. The bank confirms the client ownership, dispense the cash and extinguish the electronic money handed by the client from the record of circulating electronic money.

E. Purchasing Goods or Service with Electronic Money

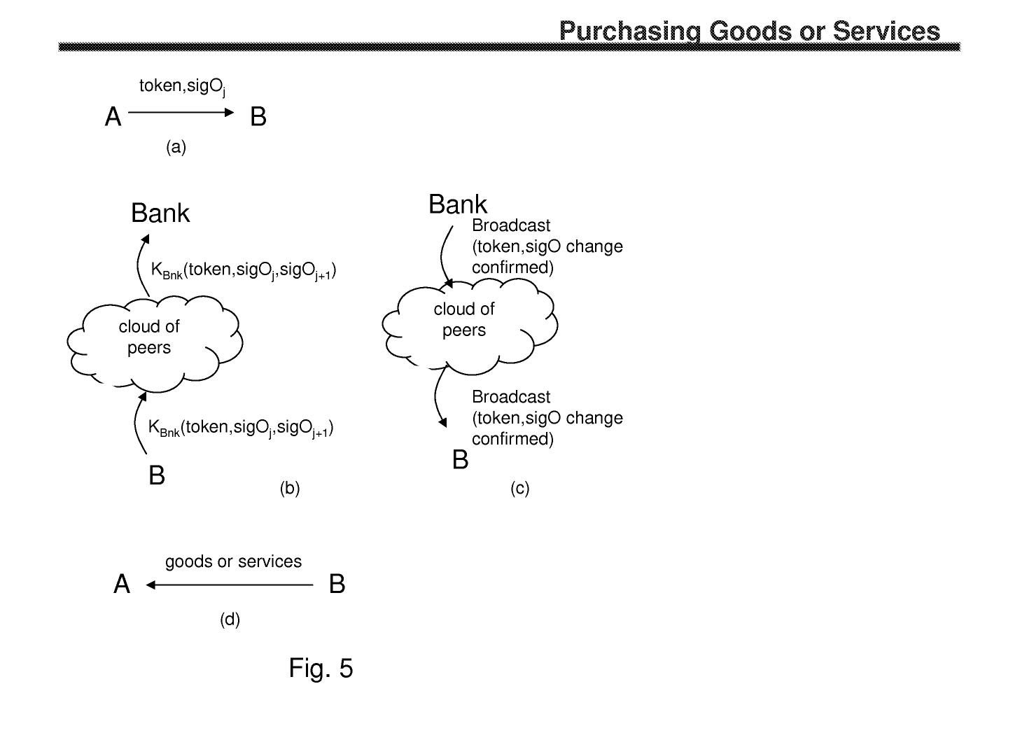

FIG. 5 shows the sequence of actions in a purchase of goods or services. In this embodiment, the transaction between client A and client B transfers electronic money anonymously between these two clients in an effect similar to a transaction using ordinary cash.

In an embodiment, client A's mobile device may be in close proximity to client B's mobile device. Alternatively, client B can make use of a fixed device running an application that can talk to client A's mobile device. Or, it still possible client A and client B are physically away from each other and might be using the internet for their exchange. The skilled in the art will recognize still other alternative scenarios that can be considered without departing from the spirit of this invention.

In FIG. 5a, in an embodiment, client A uses public key of client B to communicate the token number of all the cents he has and are necessary to purchase goods or services from B. Client A also informs the ownership content (sigO) associated with each cent of electronic money whose token number he/she informed B for the purchase. In an alternative embodiment clients A and B use a secure communication channel and client A communicates both token and ownership content without encryption. The skilled in the art will recognize other embodiments possible without departing from the spirit of the invention.

After receiving token and ownership content information from client A, client B communicates with the bank using the bank's public key, and, making use of the cloud of peers, anonymously requests the bank to change the ownership content of each cent of electronic money B received from A for paying for goods or services.

If current ownership content (sigOⱼ, FIG. 5b) in the bank's database is matched, the bank broadcasts to all clients confirmation of the change in ownership content for each token the bank was requested to change (FIG. 5c). Client B may keep time stamps and repeat the anonymous request of change in ownership of the electronic money he has just received from A with the intention of assuring the bank is really confirming his/her request of change of ownership and not an accidental effect of client A trying to double spend. Once B confirms he is the owner changing the ownership contents, B delivers the goods or services to A.

Because of this procedural construction, client A will not know the ownership content of any of the cents of electronic money after client B successfully changed its content, and double spending is therefore precluded. This is also one of the important innovations in this disclosure.

The skilled in the art will recognize that several alternative possible actions are available to client B while requesting change of ownership for each of the electronic money he received from client A now in his (B's) possession. Client B may request the bank to immediately convert it in cash and deposit in one of his (B's) accounts. Client B may also participate in another transaction with a different client C and use the just received electronic money now in his legitimate possession to pay for goods or services from client C. In this way, the electronic money can circulate in the economy, representing value to its owner in ways very similar to ordinary cash.

### F. Transferring Electronic Money

The skilled in the art will recognize the transfer of electronic money and its deposit into an account as ordinary cash can be implemented with an embodiment that uses a combination of the procedures in the cases A to E already discussed above in this document. The final transfer and deposit in cash can be anonymously done or done with the payer identified as discussed in the cases above.

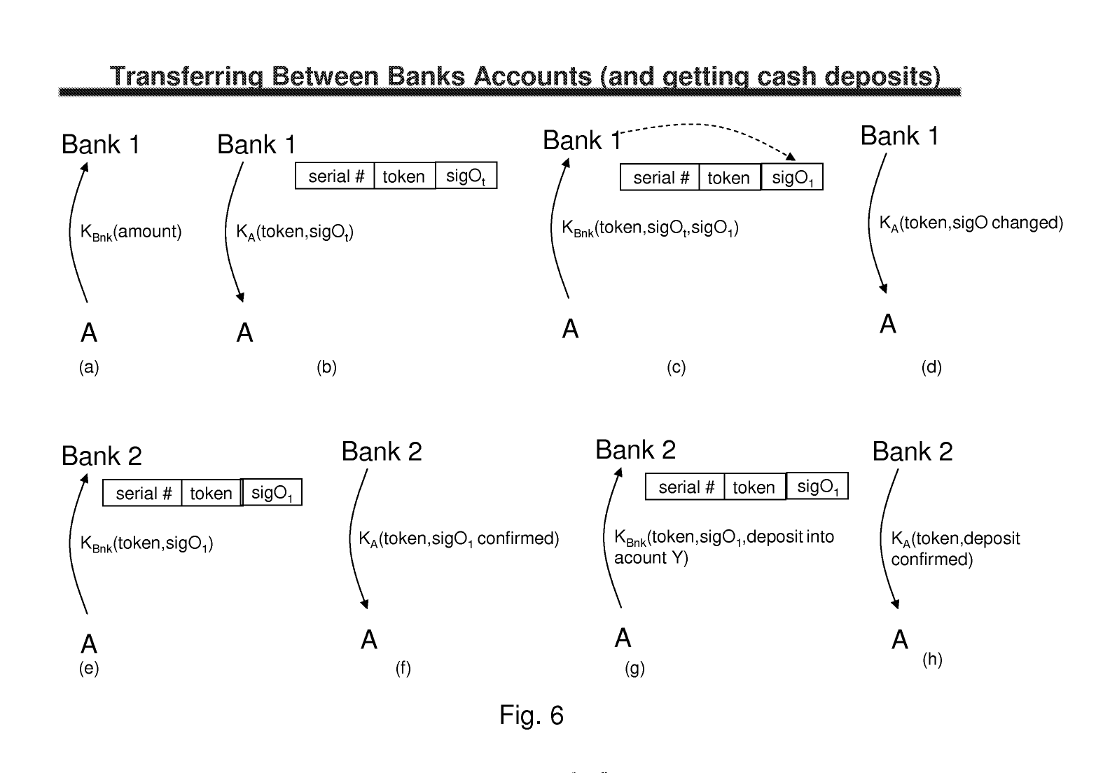

FIG. 6 shows one of such embodiments in simplified description. The loading of the client's A wallet with electronic money is made with the beneficiary, client A, identified. The deposit is also made in an account with the payer identified. In this embodiment, client A transfers money from accounts of his/hers in two different banks, Bank 1 and Bank 2, which are members of the same bank association supporting the electronic money service of which A is a client. In FIG. 6a, in a embodiment, client A loads his mobile device with electronic money. Client A exchange messages with the bank to change the ownership content of each cent of electronic money he received (FIGS. 6a to 6d) and proceeds to communicate with Bank 2 to make deposit in his account Y (FIGS. 6e to 6h).

Note that in the final step, where electronic money is converted into ordinary cash anonymity may or may not be desired as discussed in a previous case in this document. Both options, with or without anonymity, are nevertheless supported by the invention in this disclosure.

The skilled in the art will recognize that several alternative embodiments are possible without departing from the spirit of the invention. Some of these alternatives will become very similar to the operation of wiring ordinary cash between accounts of the same person or of different people.

### G. Remittances

In an embodiment, the electronic money system in this disclosure can support remittances. Remittance will be seeing as a mere transfer between clients. The support for remittances from an operational perspective is the agreement between banks in different locations that they will always honor any conversion from electronic money to ordinary cash once the legitimacy of the electronic money and its ownership can be demonstrated by a client to the bank converting electronic money into cash. Given this agreement, and the provision that if the transfer will cross national borders, electronic money will be deposited or cashed using the local denomination, the electronic money system in this disclosure can be used to sent money or make payment to any person in any part of the globe.

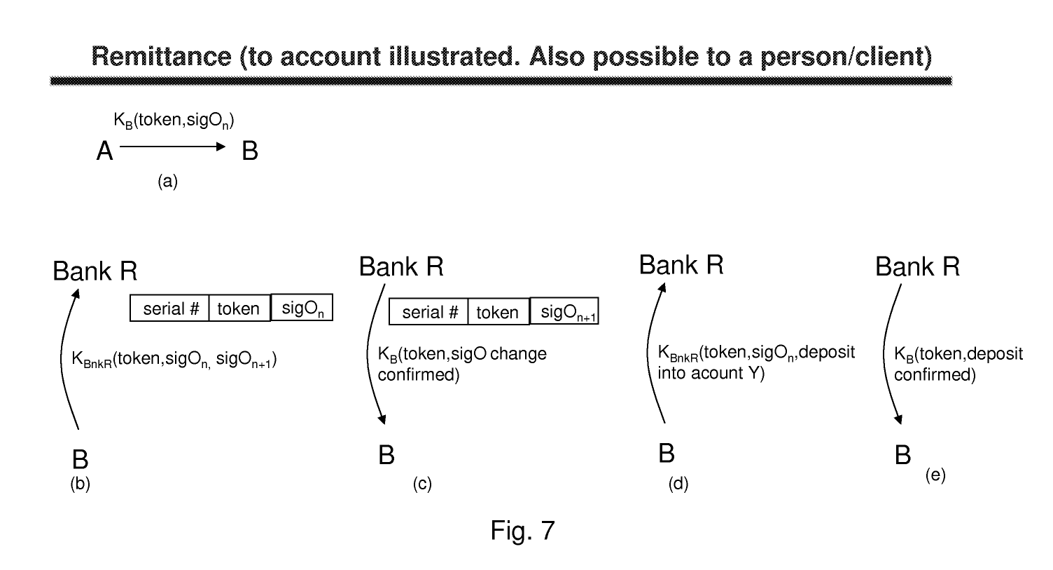

FIG. 7 shows an embodiment where a client A informs client B of the token and ownership content of the electronic money client A intends to transfer to B. Its assumed client A and B live in different countries and client A and B might communicate through the internet. In the latter case, client A uses client B's public key to inform token and ownership contents to client B (FIG. 7a). The skilled in the art will recognize that this procedure can be made to maintain anonymity of client A, who send the electronic money, if A for instance make use of the cloud of peers.

Client B then proceeds contacting his bank, Bank R, and requests a confirmation of token validity and change in ownership content (FIGS. 7b to 7c). Bank R shares the database of the bank association where information on the electronic money in circulation resides and can confirm if the token presented by client B to Bank R is legitimate and the ownership content provided by B matches the ownership content in the bank database.

After receiving confirmation from Bank R (FIG. 7c), client B requests the electronic money be converted to cash (in client B's local currency) and deposited in account Y in the same bank.

The skilled in the art will recognize client B could have requested the money to be withdrawn in local currency, and could have made this withdrawal anonymously.

In the electronic money system of this provisional patent application, since electronic money can change ownership repeatedly, there is no need to destroy or generate new electronic money after each transaction. This allows for keeping electronic money circulating in the economy in ways similar to ordinary cash. Electronic money is only extinguished when a client request its conversion to ordinary cash, either for a deposit or for withdrawal.

Cases A to G are illustrations of usages for electronic money only. The skilled in the art will recognize that the fundamental steps client and banks used in the illustrative cases A to G above can be rearranged to effect other purposes in financial transaction without departing from the spirit of the invention.

The skilled in the art will promptly recognize that other ways to describe a system based in this invention would be an electronic money system, where a client uses electronic money for purchase of goods or services. The electronic money system, where client purchase goods or service by transferring to a seller of good or services information on the ownership content of the electronic money said client is giving said seller in exchange for said goods or services. The electronic money system, where said seller of goods or services only accepts electronic money after being able to confirm the electronic money numbers are valid and that said seller can change the ownership content of said electronic money. The electronic money system, where a client can request conversion of electronic money under his/her ownership into cash to be deposited into one of his accounts in a bank in the electronic money system. The electronic money system, where a client can request conversion of electronic money under his/her ownership into physical cash to be handled to him/her. The electronic money system, where said client can make said request anonymously. The electronic money system, where a first client can transfer ownership of his electronic money to a second client by communicating to said second client information about numbers and ownership content of said electronic money. Transfer is completed when second client changes the ownership content. The electronic money system, where a part managing the circulation of electronic money manages the electronic money it generates at request of a client and also manages changes in ownership content of said electronic money generated. The electronic money system, where said part managing the circulation of electronic money is queried by the clients about the validation of the numbers of an electronic money. The electronic money system, where said part managing the circulation of electronic money is requested to change the ownership content upon presentation by a client of current ownership content. The electronic money system, where for each electronic money generated by a participant in the system, said participant broadcasts a key and the results of each of the serial numbers of electronic money to the clients in the system. The electronic money system, where a receptor of electronic money can check its validity by either requesting confirmation for the electronic money numbers from a participant which generates electronic money in the system or by encrypting said electronic numbers with said key and checking if the results are among the results said participant broadcasted. The electronic money system, where electronic money is kept in circulation changing owners and used for multiple transactions. The electronic money system, where transactions different from the generation of electronic money can be made by a client either identifying himself/herself or anonymously. The electronic money system, where a client choosing to remain anonymous use a cloud of peers to forward his requests or transfer of electronic money ownership. The electronic money system, where electronic money extinguishes when converted to cash. The electronic money system, where an application is downloaded to a computer, tablet, smartphone or mobile device to support the electronic money transactions for a client. The electronic money system, where a client subscribe to the electronic money service by paying a subscription fee with a time to expire. The electronic money system, where a client pay the subscription fee to the electronic money service to download the application to support the electronic money transactions. The electronic money system, where subscription fee to the electronic money service entitles a client to convert electronic money he/she owns into cash anytime he/she requests. The electronic money system, where said subscription fee to the electronic money service includes insurance against fraud.

The skilled in the art will promptly recognize that other ways to describe a method based on this invention would be: an electronic money method, where a client uses electronic money for purchase of goods or services. The electronic money method, where client purchase goods or service by transferring to a seller of good or services information on the ownership content of the electronic money said client is giving said seller in exchange for said goods or services. The electronic money method, where said seller of goods or services only accepts electronic money after being able to confirm the electronic money numbers are valid and that said seller can change the ownership content of said electronic money. The electronic money method, where a client can request conversion of electronic money under his/her ownership into cash to be deposited into one of his accounts in a bank in the electronic money system. The electronic money method, where a client can request conversion of electronic money under his/her ownership into physical cash to be handled to him/her. The electronic money method, where said client can make said request anonymously. The electronic money method, where a first client can transfer ownership of his electronic money to a second client by communicating to said second client information about numbers and ownership content of said electronic money. Transfer is completed when second client changes the ownership content. The electronic money method, where a part managing the circulation of electronic money manages the electronic money it generates at request of a client and also manages changes in ownership content of said electronic money generated. The electronic money method, where said part managing the circulation of electronic money is queried by the clients about the validation of the numbers of an electronic money. The electronic money method, where said part managing the circulation of electronic money is requested to change the ownership content upon presentation by a client of current ownership content. The electronic money method, where for each electronic money generated by a participant in the system, said participant broadcasts a key and the results of each of the serial numbers of electronic money to the clients in the system. The electronic money method, where a receptor of electronic money can check its validity by either requesting confirmation for the electronic money numbers from a participant which generates electronic money in the system or by encrypting said electronic numbers with said key and checking if the results are among the results said participant broadcasted. The electronic money method, where electronic money is kept in circulation changing owners and used for multiple transactions. The electronic money method, where transactions different from the generation of electronic money can be made by a client either identifying himself/herself or anonymously. The electronic money method, where a client choosing to remain anonymous use a cloud of peers to forward his requests or transfer of electronic money ownership.

### 2.0 Business Models

The invention in this disclosure describe the means to created electronic money with functionality and operations very close to ordinary cash. As tablets and smart phones become progressive more popular, computing power is available at the hands of every person to provide him/her with the benefits and convenience of electronic money.

The skilled in the art will recognize that even though embodiments described in this document make reference to mobile devices, it will be also readily recognized that those transactions need not be exclusive to mobile devices. Purchases and transfers can be made with laptop or desktop computers or even dedicated hardware for the handling of electronic money according to this invention.

Banks and financial institutions can benefit from this invention in a variety of operation and conversion fees plus specific percentages of the actual value transferred or remitted, or fees whenever electronic money is converted into cash, or when electronic cash generated in one country under a given denomination is remitted for payment at different country under another denomination. This latter case would be a conversion fee.

Another business model can be added that is germaine to the new electronic nature of this electronic money and the computational resources required to process them at each client's mobile device, laptop or desktop computer. In one embodiment, the computing resources required at each client's mobile device can be an application (software) to be downloaded and possibly paid for by an yearly subscription fee. It's possible also that such a yearly subscription fee become even more attractive if it entitle the client who installed it to an insurance against counterfeiting, misappropriation of his/her assets, or against any risk a client might be exposed to.

In the interest stabilizing the electronic cash system against unanticipated events, a cap may be used to limit the electronic money generated and loaded to an individual computer or mobile device per day, and it might be a function of the volume of electronic money in circulation.

The banks offering electronic money might offer insurance for the conversion of e-money to cash any time a client make the request as part of the subscription fee to the electronic money service. This subscription fee, as mentioned, could be paid for downloading the application for electronic money to the client's computers, tablet or smartphone.

1. An electronic money system where ownership of an electronic money amount is assigned to any one of the clients in the system who can change an specific secret content, called ownership content, associated with said electronic money amount.

2. the electronic money system of 1, where to change the specific content, the client requesting the change needs to present the current content and inform the new content.

3. the electronic money system of 1, where to change said specific content the client send the request through at least one peer.

4. the electronic money system of 1, where to change said specific content the client send the request to a pre-determined forwarding node.

5. the electronic money system of 1, where a participant keeps information on each cent of electronic money and its corresponding specific content, which is used to determine ownership.

6. the electronic money system of 1, where clients request a participant to change ownership content while also presenting to said participant with the current content of said ownership content.

7. the electronic money system of 6, where clients make request to change ownership and communicate it to a participant, encrypting his/her request using one of the participant's public key.

8. the electronic money system of 7, where the client request goes to at least one forwarding part in the system before reaching the participant which manages the electronic money circulation.

9. the electronic money system of 8, where the participant responsible for managing the circulation of electronic money responds confirming change of ownership content by broadcasting to all clients

10. the electronic money system of 1, where client request the participant managing the circulation of electronic money an amount from his cash, reserves, assets or investments be converted into electronic money.

11. A method for electronic money where ownership of an electronic money amount is assigned to any one of the clients in the system who can change an specific secret content, called ownership content, associated with said electronic money amount.

12. the electronic money method of 11, where to change the specific content, the client requesting the change needs to present the current content and inform the new content.

13. the electronic money method of 11, where to change said specific content the client send the request through at least one peer.

14. the electronic money method of 11, where to change said specific content the client send the request to a pre-determined forwarding node.

15. the electronic money method of 11, where a participant keeps information on each cent of electronic money and its corresponding specific content, which is used to determine ownership.

16. the electronic money method of 11, where clients request a participant to change ownership content while also presenting to said participant with the current content of said ownership content.

17. the electronic money method of 16, where clients make request to change ownership and communicate it to a participant, encrypting his/her request using one of the participant's public key.

18. the electronic money method of 17, where the client request goes to at least one forwarding part in the system before reaching the participant which manages the electronic money circulation.

19. the electronic money method of 18, where the participant responsible for managing the circulation of electronic money responds confirming change of ownership content by broadcasting to all clients

20. the electronic money method of 11, where client request the participant managing the circulation of electronic money an amount from his cash, reserves, assets or investments be converted into electronic money.
